(19) United States
(12) Patent Application Publication
(10) Pub. No.: US 2010/0050739 A1
(43) Pub. Date: Mar. 4, 2010

(54) Sintered and bonded multilayer sensor

(76) Inventors: Jesse Nachlas, Salt Lake City, UT (US); Balakrishnan G. Nair, Sandy, UT (US); Raymond Ashton Cutler, Bountiful, UT (US); Thomas Koerner Pace, Salt Lake City, UT (US); Gangqiang Wang, Salt Lake City, UT (US); Troy A. Small, Lake Jackson, TX (US)

Correspondence Address: CATERPILLAR/FINNEGAN, HENDERSON, L.L.P., 901 New York Avenue, NW, WASHINGTON, DC, 20001-4413, US

(21) Appl. No.: 12/230,456

(22) Filed: Aug. 29, 2008

(51) Int. Cl. G01N 27/407; H01R 43/00

(52) U.S. Cl. 73/23.31; 29/825

(57) ABSTRACT

A gas sensor may include a sintered heating component which includes a ceramic insulating material, and a separately sintered sensing component which includes an ionically conductive material. The sensor may also include a bond attaching the sensing component to the heating component. The bond may be made of bonding material which is different from the insulating material and the ionically conductive material.

### TECHNICAL FIELD

The present disclosure relates generally to a sensor, and more particularly, to a multilayer sensor having components that are first sintered and then bonded.

### BACKGROUND

The composition of exhaust produced by the combustion of hydrocarbon fuels is a complex mixture of oxide gases (NOₓ, SOₓ, CO₂, CO, H₂O), unburned hydrocarbons, and oxygen. Measurement of the concentration of these individual exhaust gas constituents in real time can be used to improve combustion efficiency and lower emissions of polluting gases. Various devices have been proposed to operate as exhaust gas sensors that have the capability of measuring the concentration of a gas in an exhaust stream.

These exhaust gas sensors may be configured as a multilayer ceramic package that includes a sensing component and a heating component. The sensing component includes a plurality of electrodes (e.g., a reference electrode and a sensing electrode) disposed on opposing sides of an electrolyte substrate. The heating component includes a heating element bonded to an electrically insulating substrate. The sensing component and the heating component are fabricated using ceramic ionically conductive and insulating materials (typically zirconia and alumina). In a typical fabrication process, the respective ceramic material in powder form may be mixed with binders and/or plasticizers and pressed together to form a sheet of the ionically conductive or insulating material. These sheets are typically referred to in the art as green sheets. Electrodes and heaters are also incorporated into the green sheets of the ionically conductive and insulating materials. The ionically conductive and insulating green sheets are then stacked together and sintered to densify the ceramic and to bond the components together.

Although perhaps effective in some situations, fabrication of the gas sensor in the method described above can be problematic. Specifically, because typical ionically conductive and insulating materials (such as, zirconia and alumina) have different coefficients of thermal expansion (CTE), the sensing and heating components will expand at different rates when sintered together, and during operation. This thermal expansion mismatch induces stresses in the sensor that may result in cracking. In the past, cracking has been mitigated by providing an interfacial layer of material having a CTE somewhere between that of the ionically conductive and insulating material. In some sensors that use zirconia as the ionically conductive material and alumina as the insulating material, the interfacial layer may be a mixture of zirconia and alumina. By utilizing an interfacial layer of intermediate CTE, the stress induced within the gas sensor during relative expansion and contraction of the zirconia and alumina layers may be reduced, resulting in less cracking of the sensor. While the use of an interfacial layer may reduce the likelihood or occurrence of cracking during fabrication and operation of the gas sensor, the interfacial layer may increase thermal resistance between the sensing component and the heating component. Additionally, the effectiveness of the interfacial layer in reducing the CTE mismatch induced stress in the sensor may be low when the thickness of the interfacial layer is small.

An alternative method for producing a multilayer ceramic gas sensor is disclosed in US Patent Application Publication No. 2002/0008024 (the '024 publication) by Sugiyama published on Jan. 24, 2002. Specifically, the '024 publication discloses a multilayer sensor having a zirconia electrolytic sheet and an alumina insulating sheet. The boundary between the sheets includes a bonding material which is a crystal phase of SiO₂. Prior to sintering the zirconia green sheet to the alumina green sheet, a paste containing the SiO₂ is applied to the mating surfaces of the green sheets. During sintering, the paste liquifies and, upon cooling, crystallizes to bond the densified sheets of zirconia and alumina together. In one embodiment, a mixture containing SiO₂ is also blended with the zirconia and alumina during green sheet formation to enhance bonding. The SiO₂ mixture may sufficiently bond the electrolytic sheet to the insulating sheet and has a CTE somewhere between that of zirconia and alumina. In addition, the SiO₂ mixture may remain durable when exposed to high temperatures.

Although perhaps an improvement over previous sensors, the gas sensor of the '024 publication may still have reduced reliability in some applications. That is, the SiO₂ mixture may have a liquification temperature somewhat lower than the required sintering temperatures of the zirconia and alumina green sheets. As a result, the mixture may decrease in viscosity to an uncontrollable level when exposed to the sintering temperatures, possibly resulting in an uncontrolled flow of the mixture to undesired areas of the sensor (i.e., the liquid mixture may flow to and contaminate electrical contacts of the sensor). Additionally, the liquid mixture may react with some of the materials of the sensor.

The disclosed sensor is directed at overcoming the shortcomings discussed above and/or other shortcomings in existing technology.

### SUMMARY OF THE DISCLOSURE

In one aspect, the present disclosure is directed to a gas sensor. The gas sensor may include a sintered heating component which includes a ceramic insulating material, and a separately sintered sensing component which includes an ionically conductive material. The sensor may also include a bond attaching the sensing component to the heating component. The bond may be made of bonding material which is different from the insulating material and the ionically conductive material.

In another aspect, the present disclosure is directed to a method of fabricating a gas sensor. The method may include sintering a ceramic insulating material to form a heating component of the gas sensor, and separately sintering an ionically conductive material to form a sensing component of the gas sensor. The method may further include attaching the sensing component to the heating component using a bonding material, the bonding material may be different from the insulating material and the ionically conductive material. In yet another aspect, the present disclosure is directed to a sensor. The sensor may include a heating component fabricated from a spinel based material having a weight ratio of MgO:Al₂O₃ between about (0.9-1.1):1, and a sensing component. The sensing component may be fabricated from a YSZ based material.

### BRIEF DESCRIPTION OF THE DRAWINGS

FIG. 1 is an illustration of an exemplary sensor;

FIG. 2 is a schematic illustration of the components of the sensor of FIG. 1;

FIG. 3 is a flow chart of an exemplary fabrication process of the sensor of FIG. 1;

FIG. 4 is a schematic of a cross-section of the sensor of FIG. 1; and

FIG. 5 is a graphical illustration of the coefficient of thermal expansion of the components of the sensor of FIG. 1.

### DETAILED DESCRIPTION

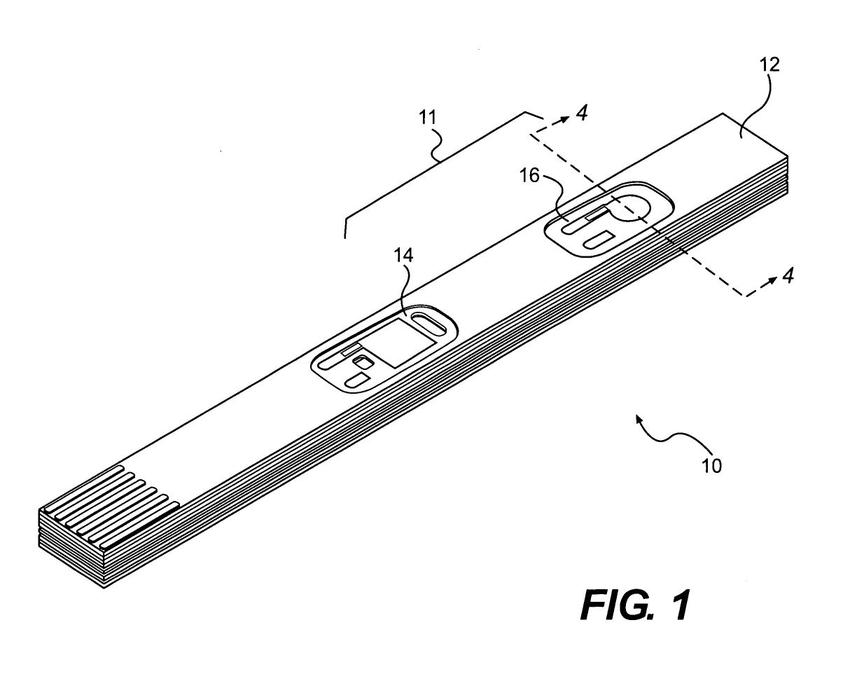

FIG. 1 illustrates a sensor 10 configured to sense a gaseous constituent in exhaust gases. Sensor 10 may include an assembly of multiple components, including at least one heating component 12 and at least one sensing component 11. The embodiment of FIG. 1 illustrates sensor 10 as having two sensing components 11, including a first sensing component 14 and a second sensing component 16. In the discussion that follows, first sensing component 14 and a second sensing component 16 may be collectively referred to as sensing component 11. In this embodiment, first sensing component 14 may be directed to sense the presence of a first constituent, for example NOₓ, within an exhaust stream of an engine, while second sensing component 16 may be directed to sense the presence of a second constituent, for example O₂, within the same exhaust stream. Although two sensing components are illustrated in FIG. 1, any number of sensing components may be included in sensor 10, and these sensing components may be configured to sense any gaseous constituent. First and second sensing components (14, 16) may be fabricated separately and then bonded to heating component 12, as will be described in more detail below. Although sensor 10 is described as being a gas sensor, it is contemplated that sensor 10 may be any type of sensor.

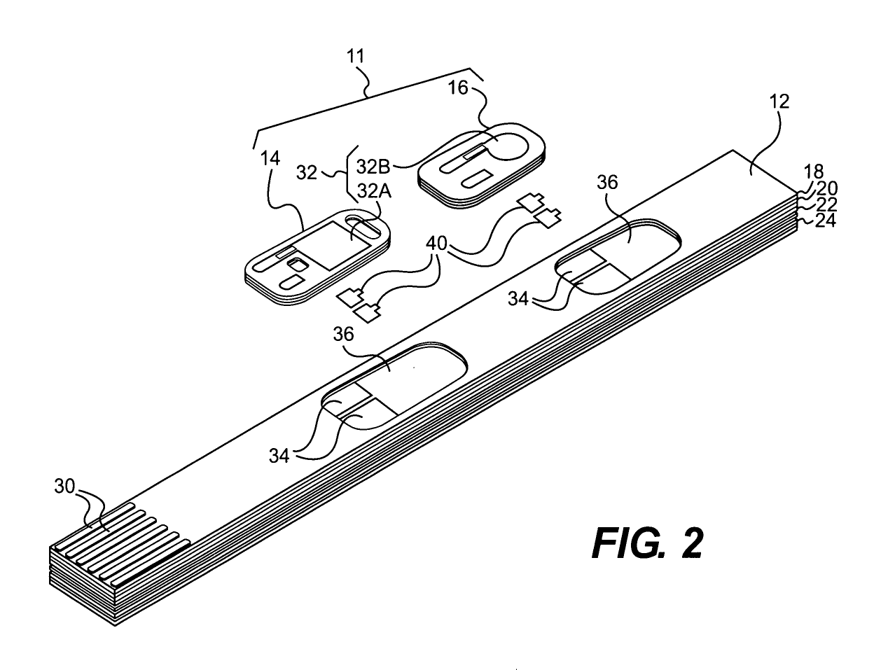

FIG. 2 illustrates a schematic view of the sensing and heating components that make up sensor 10. As indicated earlier, although two sensing components (first sensing component 14 and second sensing component 16) are illustrated in FIG. 2, sensor 10 may include any number of sensing components. Heating and sensing components (12, 11) may include any type of ceramic heating and sensing component (12, 11) known in the art. It some embodiments, one or both of heating and sensing components (12, 11) may be a multi-layer ceramic structure. In the description that follows, an embodiment of a sensor 10 with a ceramic heating component 12 and ceramic sensing component 11 is described. However, it should be emphasized that, in general, sensors of the current disclosure may include any type of heating component 12 and sensing component 11.

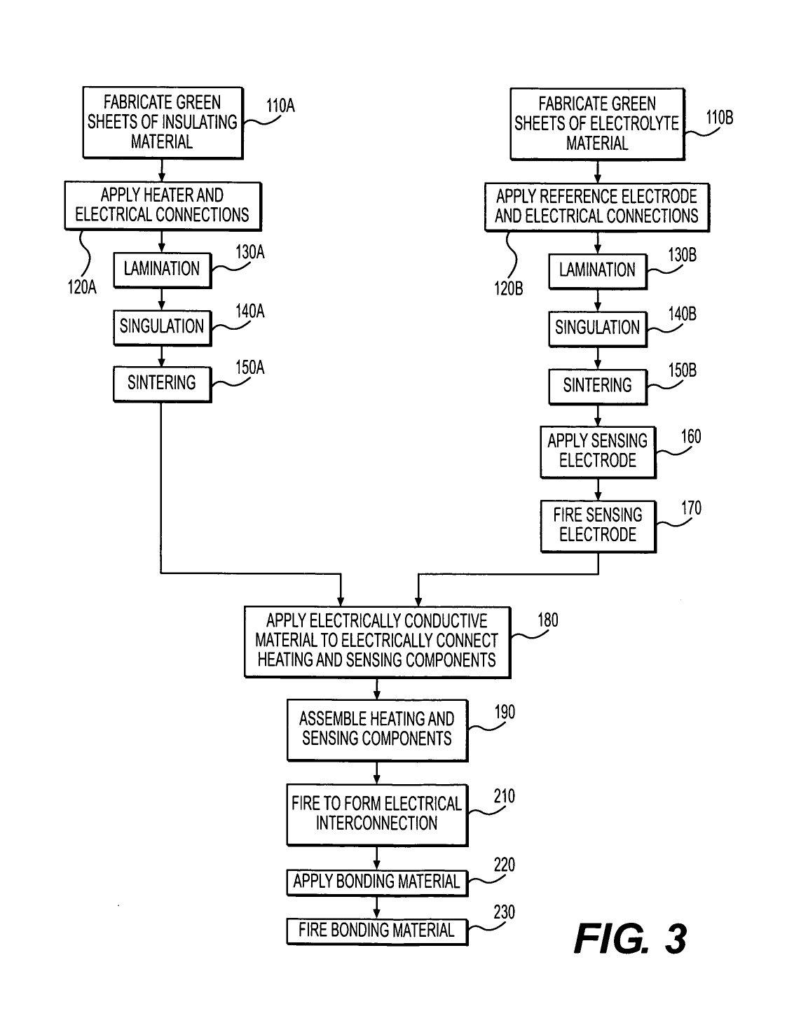

FIG. 3 illustrates a flow chart for fabricating sensor 10. In the description that follows, reference will be made to both FIGS. 2 and 3. Heating component 12 may include multiple layers of ceramic sheets stacked together. These multiple sheets may include individual layers 18, 20, 22, 24, etc., that may be made of an electrically insulating material. A variety of materials, such as alumina (Al₂O₃), spinel (MgAl₂O₄), etc., may be used for constructing individual layers 18, 20, 22, 24. In some embodiments, an insulating material with a coefficient of thermal expansion (CTE) tailored to match the CTE of the sensing component material may be used. A description of an exemplary material having a CTE substantially equal to the CTE of the sensing component material will be described later. In this disclosure, two materials are considered to have substantially the same CTE (or have CTE substantially matched), if the CTEs of the two materials at any temperature, in the temperature range of about 22-800° C., is within about 1 ppm/° C.

To fabricate heating component 12, individual layers 18-24 may first be formed from a powder or paste of the insulating material. The insulating material powder may be mixed with binders, solvents, and/or plasticizers and formed into a slurry, which may be tape cast and dried to form green layers of insulating material (step 110A). In the green phase, these layers may be relatively flexible due to the presence of the binders, solvents, and/or plasticizers in the material. Some of layers 18-24 may include one or more cavities 36 that may be sized to fit sensing components 11 therein. Heaters (not shown) and electrically conductive elements may then be patterned on, and between, layers 18-24 (step 120A). These conductive elements may include leads on layers, vias through the layers, and contacts 30 on the surface of heating component 12 to provide power to the heating elements, and to communicate with sensing components 11 after sensor 10 is assembled. The leads on heating component 12 that couple sensing component 11 to contacts 30 may terminate at conductive pads 34 that may be positioned on the cavities 36. When sensing component 11 is assembled on the heating components 12, these conductive pads 34 may align with corresponding conductive pads on sensing components 11. The conductive elements and heating elements may be patterned on layers 18-24 by any method, such as screen printing, known in the art.

The individual layers 18-24 may then be stacked in a desired order and laminated under heat and pressure (step 130A). The particular lamination conditions may depend upon the design details of sensor 10 and the insulating material used to form layers 18-24. For instance, if a spinel based material is used to fabricate layers 18-24, lamination may be carried out by stacking layers 18-24 and subjecting the stack to a pressure between about 1,500-10,000 psi and a temperature between about 25-100° C. In some embodiments, multiple heating components 12 may be included in the same stack of layers. In these embodiments, individual heating components 12 may be singulated from the stack after lamination (140A). Any processes known in the art, such as laser cutting, sawing, punching, etc., may be used for singulation. The singulated heating components 12 may then be sintered (150A). Sintering may be carried out by exposing the heating components 12 to a high temperature for a prolonged time. Sintering may join the powder particles of the individual layers (18-24) together to form a dense heating component 12 of unitary structure with heating elements, and electrical connections to the heating elements, embedded therein.

The time-temperature profile employed during sintering may depend upon the application. As is well known in the art, this temperature-time profile may include steps to release the organics (binders, solvents, plasticizers, etc.), and steps to sinter the powder particles together. As an illustrative example, if a spinel based insulating material is used to fabricate heating component 12, sintering may include heating layers 18-24 together for a temperature greater than about 1300° C. for over 2 hours. In some embodiments, contacts 30 may be applied to sensor 10 after sintering layers 18-24 to form heating component 12. In these embodiments, contacts 30 may be sceen printed at the appropriate location (on one or more vias to electrically connect to the embedded heating elements), and the sensor 10 heated (“fired”) to adhere the metallic material of the contact to the ceramic material of the sensor 10. As is known in the art, the firing conditions may depend upon the application.

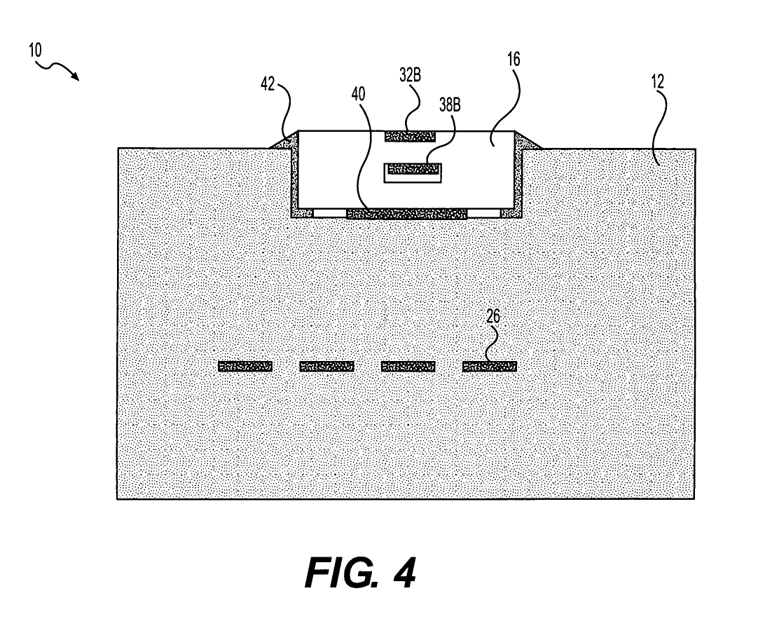

Sensing component 11 may be fabricated, mutatis mutandis, as heating component 12. As with heating component 12, sensing component 11 (first and second sensing components (14, 16)) may also include multiple layers that are sandwiched together and sintered to form sensing component 11. As is well known in the art, sensing components 11 may include a reference chamber (open reference chamber, closed reference chamber, etc.) that may assist in the functioning of sensing component 11. The layers of the sensing components 11, therefore, may be configured to form these reference chambers after they are laminated together. In place of the insulating material powder used to fabricate the layers of heating component 12, powders (or other forms of the material) of an ionically conductive ceramic material may be used to form the layers of the sensing components 11. Green layers of a ceramic ionically conductive material may be formed in the same manner as the heating component layers (step 110B). A variety of ionically conductive materials known in the art, may be used to fabricate sensing component 11. In one exemplary embodiment, an oxygen ion conductive material such as yttria stabilized zirconia (YSZ) may be used as the ionically conductive material. Reference electrodes (not shown in FIG. 2, marked 38B in FIG. 4) and electrical interconnections may then be formed on these green electrolyte sheets. The reference electrodes and the interconnections may be formed in the same manner as heating elements and interconnections of heating component 12 are formed (step 120B). In some embodiments, these reference electrodes may be positioned in a reference chamber. The conductive elements applied to the layers of sensing components 11 may terminate at conductive pads (not shown) that may align with conductive pads 34 on heating component 12 when they are assembled together.

The green electrolyte layers may then be stacked and laminated similar to the layers of the heating component 12 (step 130B). In some embodiments, multiple sensing components 11 may be included in a single green sheet. In these embodiments, individual sensor components may be singulated from the laminated sheets (step 140B). The laminated layers may then be sintered to form sensing component 11 of a unitary structure (step 150B). The sintering conditions may depend upon the material used and the design of the layers. In some embodiments, sintering may include heating the laminated layers to a temperature greater than about 1300° C. for over 2 hours.

Post sintering, sensing electrodes 32 (first sensing electrode 32A of first sensing component 14 and second sensing electrode 32B of second sensing component 16) may be formed on the sensing component 11 (step 160). Any known method, such as printing or deposition, may be used to form sensing electrodes 32 on sensing component 11. The sensing electrode 32 material may depend upon the type of sensing component 11 formed. For instance, if first sensing component 14 is a sensor to detect concentration of NOₓ, then a metal such as platinum, a metal oxide such as tungsten oxide, or a composite of metal oxides (such as, for example, tungsten oxide and zirconium oxide (WO₂/ZrO₂)) may be printed on the surface of first sensing component 14 to form first sensing electrode 32A. If sensing component 16 is a sensor that detects the concentration of oxygen, then platinum (Pt) or another suitable material may be coated on a surface of second sensing component 16 to form second sensing electrode 32B. After printing the sensing electrode 32, the sensing component 11 may be fired at a desired temperature to promote adhesion of the sensing electrode 32 to the sensing component (step 170). The firing conditions (time and temperature) may depend upon the application (materials, etc.). For instance, in an application where Pt is used as the sensing electrode and YSZ is used as the ionically conductive material, firing may include subjecting the sensing component 11 to a temperature between 800° C. and 1400° C. for a time period between about 15 minutes to 2 hours.

An electrically conductive material, such as Pt ink, may now be applied on conductive pads 34 of heating component 12 and/or on corresponding conductive pads of the sensing component 11 to form terminal contact pads 40 (step 180). In one embodiment, to apply terminal contact pads 40, a paste of the conductive material may be screen printed to conductive pad 34 and the sensing components 11 placed in the cavities 36 of heating component 12 (step 190). With the sensing component 11 placed in cavities 36, the assembly may now be joined together to form sensor 10. After the sensing components 11 are placed in cavities 36, the assembly may be fired to form terminal contact pads 40 (from the conductive material) that electrically interconnect sensing component 11 to heating component 12 (step 210). The firing conditions may depend upon the application. In general, the firing conditions may include heating the assembly to a temperature between about 750-1500° C. for a period between 15 minutes to 2 hours. In some embodiments using Pt ink as the conductive material, the assembly may be heated to a temperature between about 800-1000° C. for about 45 minutes to 1.5 hours to form terminal contact pads 40.

A bonding material may now be applied around the perimeter of cavities 36 and/or between sensing component 11 and heating component 12 (step 220) and fired (step 230) to form bond 42 between the sensing component 11 and heating component 12. FIG. 4 shows a cross-section of sensor 10 (along plane 4-4 of FIG. 1) showing the bond 42 between sensing component 11 and heating component 12. Any type of material that forms bond 42 between sensing component 11 and heating component 12 may be used as bonding material. The bonding material may be made from a material having a firing temperature lower than the sintering temperature of the ionically conductive material and the insulating material. In some embodiments, the bond material may also have a CTE substantially matched to one or both the CTEs of the ionically conductive material and the insulating material. In one example, the bonding material may be a silica based material, such as, for example commercially available E2 or S2 glass. In another example, the bonding material may be a pliable metal, for example silver. In embodiments with the bonding material in the form of a pliable metal, the bond 42 may accommodate a CTE mismatch between heating component 12 and sensing component 11 by deforming in response to the different expansions/contractions of the electrolyte and the insulating materials during heating and cooling.

After application of the bond material around the perimeter of cavities 36 (step 220), the assembled sensor 10 may be fired at a temperature between about 750° C.-1500° C. for about 15 minutes to 2 hours (step 230). In embodiments using a glass paste as the bonding material, sensor 10 may be fired to a temperature between about 900 and 1100° C. for between about half hour to an hour to form bond 42. As the temperature of sensor 10 increases, the bond material may melt and flow into a space between the sensing and heating components (11, 12). As sensor 10 is cooled, bond 42 may form joining heating component 12 to sensing component 11. In some embodiments, as depicted in FIG. 4, the bonding material may not completely fill the space between the sensing and heating components (11, 12). In some embodiments, steps 210 and 230 may be combined, and terminal contact pads 40 and bond 42 may be formed in the same operation. In these embodiments, a layer which includes both a pattern of electrical contacts between the sensing and heating components (11, 12), and a bonding material may be sandwiched between the sensing and heating components (11, 12) (that is, a combination of steps 180, 190, and 220), and the assembly subjected to a high temperature to form terminal contact pads 40 and bond 42 (steps 210 and 230).

Because the bond 42 is formed after heating component 12 and sensing components 11 have already been sintered, a distinct layer of bond 42 may be formed between these components. In contrast, if the sensing and heating components (11, 12) had been sintered together (“co-fired”), this distinct layer of bond 42 may not exist.

As described earlier, in some embodiments, heating component 12 may be made of material having substantially the same CTE as the sensing component material. In an embodiment where sensing component 11 is made of a YSZ based material, compositions of YSZ in the ionically conductive material may vary from 100% YSZ to about 67 vol % of YSZ with up to about 33 vol % of alumina or MgO aluminate spinel. To match the CTE of these electrolyte compositions, the heating component 12 may be fabricated primarily from a MgO/spinel blend material. MgO/spinel blend material may be a two-phase mixture of MgO and spinel (MgAl₂O₄). The composition of the MgO/spinel blend material may be such that its CTE may be substantially the same as the CTE of the ionically conductive material. That is, the CTEs of ionically conductive material and the MgO/spinel blend at any temperature in the temperature range of 22-800° C., may be within about 1 ppm/° C. For such a CTE match, the ratio of the MgO:Al₂O₃ in the MgO/spinel blend may change depending upon the amount of YSZ in the ionically conductive material. In general, the weight ratio of MgO:Al₂O₃ in MgO/spinel blend may vary between about (0.4-5.3):1. This weight ratio may correspond to a molar ratio of MgO:Al₂O₃ of about (1-13):1). In an embodiment where sensing component 11 is made of about 100% YSZ, MgO/spinel blend may have a weight ratio of MgO:Al₂O₃ between about (0.9-1.1):1 (that is, the molar ratio of MgO:Al₂O₃ may be about (2.1-2.8):1). In some embodiments, this MgO/spinel blend may have a MgO:Al₂O₃ weight ratio of about 1.04:1 (corresponding to a molar ratio of about 2.6:1). In contrast, typical spinel (stoichiometric spinel MgAl₂O₄) may have a MgO:Al₂O₃ weight ratio of about 0.395:1 (molar ratio of about 1:1). The increased amount of MgO in MgO/spinel blend may make the CTE of MgO/spinel blend to be substantially the same as the CTE of YSZ.

MgO/spinel blend may be formed by mixing together predetermined proportions of MgO, Al₂O₃, and Y₂O₃. Y₂O₃ may be added as a sintering aid. To fabricate MgO/spinel blend, MgO, Al₂O₃, and Y₂O₃ may be mixed with solvents (such as, toluene, and ethanol), binders (such as, Butvar™ B98), plasticizers (such as, Santicizer® 160), and dispersants (such as, Butvar™ B79) to form a mixture. In an exemplary embodiment, the mixture may contain between about 24-30 weight % of MgO, 23-30 weight % of Al₂O₃, 0-3% of Y₂O₃, 0-1% of Butvar™ B79, 20-30 weight % of Toluene, 0-10 weight % of Ethanol, 0-10 weight % of Butvar™ B98, and 0-10 weight % of Santicizer® 160. This mixture may be tape cast (step 110A), embedded with heating elements and conductors (step 120A), laminated (step 130A), singulated (step 140A), and sintered (step 150A) as described earlier. It is contemplated that in some embodiments, some or all of the solvent, binder, plasticizer, and dispersant may be eliminated. It is also contemplated that in some embodiments, in place of casting, other known processes (such as, for example, calcination) may be used to form MgO/spinel blend.

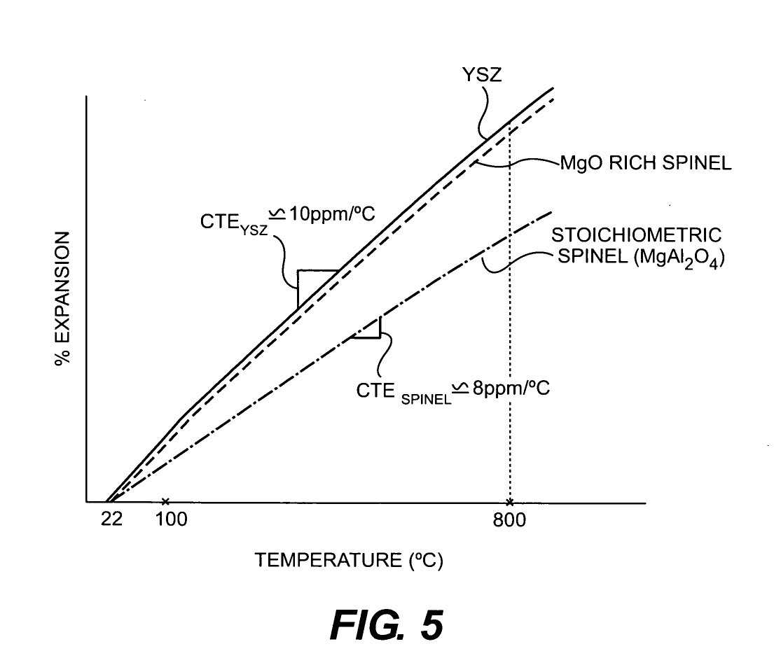

FIG. 5 is a schematic representation of the thermal expansions of stoichiometric spinel, YSZ, and MgO/spinel blend. For simplicity, the thermal expansion curves for the three materials are depicted as linear. However, in general, some or all of these curves may have a different configuration (such as, multi-linear, curved, etc). The slope of a thermal expansion curve represents the CTE of the corresponding material. Since the three thermal expansion curves in FIG. 5 are depicted as being linear, the slope of the curves, in the temperature range shown in FIG. 5, are constant. However, in general, the slope of a curve (and hence, CTE of the material) between any two temperatures within the temperature range of FIG. 5 may vary depending upon the shape of the thermal expansion curve. As seen in FIG. 5, the CTE of YSZ in the temperature range of about 22-800° C. is about 10 ppm/° C., and CTE of stoichiometric spinel in the same temperature range, is about 8 ppm/° C. As seen in FIG. 5, MgO/spinel blend may have a CTE substantially matched with the CTE of YSZ.

As described earlier, to bond heating component 12 to first and second sensing components (14, 16), the components are stacked and heated together to a high temperature to couple the components together, and then cooled to a lower temperature. During the heating step, the components are free to expand freely. However, during cooling, the solidified bond between the components will restrict relative motion between them. If the CTEs of heating component 12 and sensing components 11 are different, these components will have a tendency to contract by different amounts, thereby inducing stresses at the interface. This same phenomenon of expansion mismatch between the attached components may further induce stresses at the interface during heating and cooling of sensor 10 during operation. If, however, the CTEs of heating and sensing components (12, 11) are substantially the same, the amount of expansion (during a heating event) and contraction (during a cooling event) of these components may also be substantially the same, thereby minimizing stresses at the interface. Therefore, making heating component 12 from MgO/spinel blend may further increase the robustness and reliability of sensor 10.

### INDUSTRIAL APPLICABILITY

The presently disclosed sensor may be utilized to detect the presence of various gases within an exhaust flow of an engine, while maintaining a high degree of durability. Heating and sensing components, that make up the sensor, may be fabricated from insulating and ionically conductive materials, respectively, by laminating and sintering processes. The sintered heating and sensing components may then be bonded together using a bonding material. Since these component are sintered separately and then bonded together, a distinct bond layer may be formed between the heating and sensing components.

Specifically, by first sintering the individual sensing and heating components prior to bonding them together, differences in expansion and contraction experienced by the separate components during the sintering process may have little effect on each other. Additionally, sintering the components before bonding them together may prevent the bond material from being exposed to high sintering temperatures. By not heating the bond material to a sintering temperature significantly higher than the bonding temperature, better flow control of the melted bond material may be achieved. Further, because the sensing and heating components may already be sintered prior to contact with the bond material, the likelihood of reactions between the bond material and the electrolyte or insulating material may be minimized. Further, by fabricating the sensor using materials having substantially the same CTE, the relative differences in expansion and contraction during fabrication and operation of the sensor, that could otherwise cause the sensor to crack, may be minimized.

It will be apparent to those skilled in the art that various modifications and variations can be made to the disclosed sensor. Other embodiments will be apparent to those skilled in the art from consideration of the specification and practice of the disclosed sensor. It is intended that the specification and examples be considered as exemplary only, with a true scope being indicated by the following claims and their equivalents.

What is claimed is:

1. A gas sensor, comprising:
a sintered heating component including a ceramic insulating material;
a separately sintered sensing component including an ionically conductive material; and
a bond attaching the sensing component to the heating component, wherein the bond is made of bonding material which is different from the insulating material and the ionically conductive material.

2. The gas sensor of claim 1, wherein the heating component includes a heating element and the sensing component includes a sensing electrode and a reference electrode.

3. The gas sensor of claim 1, wherein the insulating material is a spinel-based material and the ionically conductive material is a YSZ based material.

4. The gas sensor of claim 3, wherein the insulating material is MgO/spinel blend.

5. The gas sensor of claim 4, wherein the MgO/spinel blend has a weight ratio of MgO:Al₂O₃ between about (0.9-1.1):1, and the ionically conductive material is about 100% yttria stabilized zirconia.

6. The gas sensor of claim 4, wherein the MgO/spinel blend has a weight ratio of MgO:Al₂O₃ about 1.04:1.

7. The gas sensor of claim 1, wherein the bonding material has a firing temperature lower than a sintering temperature of the heating component and a sintering temperature of the sensing component.

8. The gas sensor of claim 1, wherein the bonding material is one of a glass paste or a metallic material.

9. The gas sensor of claim 1, wherein a coefficient of thermal expansion of the insulating material is substantially the same as a coefficient of thermal expansion of the ionically conductive material.

10. A method of fabricating a gas sensor, comprising:
sintering a ceramic insulating material to form a heating component of the gas sensor;
separately sintering an ionically conductive material to form a sensing component of the gas sensor; and
attaching the sensing component to the heating component using a bonding material, the bonding material being different from the insulating material and the ionically conductive material.

11. The method of claim 10, wherein attaching the sensing component includes firing the bonding material at a temperature below a sintering temperature of the heating component and a sintering temperature of the sensing component.

12. The method of claim 10, wherein attaching the sensing component includes forming an electrical interconnection between the sensing component and the heating component.

13. The method of claim 12, wherein forming the electrical interconnection includes applying an electrically conductive material between the sensing component and the heating component and firing the electrically conductive material to form the electrical interconnection.

14. The method of claim 10, wherein sintering the ceramic insulating material includes laminating one or more green sheets of the ceramic insulating material with a heating element attached thereto.

15. The method of claim 10, wherein;
sintering the ceramic insulating material includes fabricating a green sheet of the ceramic insulating material from a MgO/spinel blend having a weight ratio of MgO:Al₂O₃ between about (0.4-5.3):1; and
separately sintering the ceramic ionically conductive material includes fabricating a green sheet of the ceramic ionically conductive material from a YSZ based material, the YSZ based material including about 67-100 vol % of YSZ with a remainder being one of alumina or MgO aluminate spinel.

16. The method of claim 15, wherein a coefficient of thermal expansion of the insulating material is substantially the same as a coefficient of thermal expansion of the ionically conductive material.

17. The method of claim 15, wherein the weight ratio of MgO:Al₂O₃ in the MgO/spinel blend is about between about 1.04:1.

18. The method of claim 10, wherein:
sintering the ceramic insulating material includes fabricating a green sheet of the ceramic insulating material from a MgO/spinel blend having a weight ratio of MgO:Al₂O₃ between about (0.9-1.1):1; and
separately sintering the ceramic ionically conductive material includes fabricating a green sheet of the ceramic ionically conductive material from about 100% YSZ.

19. A sensor, comprising:
a heating component fabricated from a spinel based material having a weight ratio of MgO:Al₂O₃ between about (0.9-1.1):1; and
a sensing component, the sensing component being fabricated from a YSZ based material.

20. The sensor of claim 19, wherein the spinel based material has a weight ratio of MgO:Al₂O₃ of about 1.04:1.

21. The sensor of claim 20, wherein the YSZ based material is about 100% YSZ.

22. The sensor of claim 20, wherein a coefficient of thermal expansion of the spinel based material is substantially the same as a coefficient of thermal expansion of the YSZ based material.

23. The sensor of claim 20, wherein the heating component is attached to the sensing component with a bond.
